(19) United States
(12) Patent Application Publication
(10) Pub. No.: US 2014/0169414 A1
(43) Pub. Date: Jun. 19, 2014

(54) METHOD FOR OPERATING A COMMUNICATION SYSTEM AND COMMUNICATION SYSTEM

(71) Applicant: Stian Skorstad Moen, Sjetnemarka (NO)

(72) Inventor: Stian Skorstad Moen, Sjetnemarka (NO)

(21) Appl. No.: 14/233,875

(22) PCT Filed: Jul. 13, 2012
(86) PCT No.: PCT/EP2012/063800

§ 371 Date: Jan. 20, 2014

(30) Foreign Application Priority Data
Jul. 21, 2011 (EP) 11174850.5

(51) Int. Cl. H04L 7/033; H04B 13/02

(52) U.S. Cl. CPC H04L 7/033; H04B 13/02
USPC 375/218

(57) ABSTRACT

A method for operating a communication system including a first device with a working oscillator and a second device with a reference oscillator is provided. The method includes calibrating the working oscillator of the first device connected to an asynchronous serial communications bus. The calibrating includes defining a measurement time, and measuring and selecting a predefined pulse space of a first signal. The predefined pulse space of the first signal is formed by a plurality of predefined discrete pulse spaces, generated by a second device including a reference oscillator, and received by the first device during the measurement time over the asynchronous serial communications bus.

The present patent document is a §371 nationalization of PCT Application Serial Number PCT/EP2012/063800, filed Jul. 13, 2012, designating the United States, which is hereby incorporated by reference. This patent document also claims the benefit of EP 11174850, filed Jul. 21, 2011, which is also hereby incorporated by reference.

### FIELD

The present embodiments relate to a method for operating a communication system, a communication system, and a program element.

### BACKGROUND

Communication systems may include a plurality of devices (e.g., sensors and actuators). To reduce the wiring complexity, these devices are connected via asynchronous serial communication busses.

Communication over asynchronous serial communication busses relies on predefined bit rates. Accordingly, two devices communicating over an asynchronous communication bus are to be operated at the same bit rate derived from the frequency of the respective working oscillators. As bit rate increases, the accurateness of the oscillators becomes more important to avoid transmission errors.

Providing each device with a high precision oscillator may be expensive and/or may not be possible due to environmental conditions like, for example, high pressure or extreme temperatures.

### SUMMARY AND DESCRIPTION

The scope of the present invention is defined solely by the appended claims and is not affected to any degree by the statements within this summary.

There may be a need for a method for operating a communication system, a communication system and a program element offering a higher flexibility concerning the choice of oscillators. The present embodiments may obviate one or more of the drawbacks or limitations in the related art. For example, the need described above may be met by the present embodiments.

A pressurized environment may denote an enclosure having a pressure in the inside that equals the pressure at the outside (e.g., the pressure is balanced). The enclosure may be a fluid filled container (e.g., a container filled with an incompressible liquid). A pressurized environment may be less prone to the risk of collapsing due to high subsea pressures.

An atmospheric canister may, for example, denote an enclosure with pressure that approximately equals the standard pressure. The standard pressure may be defined as 1013.25 hPa or 1000 hPa. An atmospheric canister may provide constant pressure conditions. For example, reference oscillators encapsulated within an atmospheric canister may maintain a constant frequency.

According to a first aspect, a method for operating a communication system includes a first device with a working oscillator and a second device with a reference oscillator. The method includes calibrating the working oscillator of the first device connected to an asynchronous serial communications bus, and calibrating. The calibrating includes defining a measurement time T_{A}, measuring and selecting a shortest pulse space T₁ of a first signal formed by a plurality of predefined discrete pulse spaces, generated by a second device including a reference oscillator, and received by the first device during the measurement time T_{A} over the asynchronous serial communications bus.

The pulse space (e.g., the time between a first edge and a subsequent edge) of a signal transmitted via an asynchronous serial communications bus directly relates to the frequency of the oscillator of the transmitting device. The first signal characterized by a plurality of predefined discrete pulse spaces may be a signal intended for any device connected to the asynchronous serial communications bus. The pulse spaces may be multiples of a base period (e.g., a period of the resonance oscillator). The first signal received by the first device may, for example, be formed by a first pulse space and another pulse space. These two pulse spaces may be distinguished as the signal is formed by pulse spaces being discrete. The first device may select, for example, the predefined pulse space to be the pulse space corresponding to two times the period of the resonance oscillator. As the first device may measure the predefined pulse space in terms of a working oscillator of the first device, the first device may determine the deviation of the frequency of the working oscillator compared to the reference oscillator. The time T_{A} may be selected to provide that a predefined pulse space may be detected in the first signal. Selecting the predefined pulse space to be the shortest pulse space may allow for reducing T_{A}.

Calibrating may be comparing a value (e.g., the frequency) of a working device with the corresponding value of a reference device and determining the difference.

According to a first embodiment of the method for operating a communication system, the method further includes adjusting the frequency of the working oscillator. Adjusting refers to influencing the working oscillator to reduce the frequency difference between the working oscillator and the reference oscillator (e.g., to rendering the difference negligible or even zero). This may enhance transmission speeds. Furthermore, this may allow the first device to perform precise time measurements.

According to a second embodiment of the method for operating a communication system, the method further includes adapting a calculation of an operating bit rate of the first device. Adapting the bit rate may allow a stable data transmission without requiring an adjustable working oscillator.

According to another embodiment of the method for operating a communication system, the method further includes validating the calibration of the working oscillator of the first device. Validating the calibration of the working oscillator may help to reduce erroneous transmissions.

According to a further embodiment of the method for operating a communication system, validating the calibration of the working oscillator of the first device includes periodically sending predefined signals from the second device over the asynchronous serial communications bus. This may further reduce erroneous transmissions and enhance the reliability of the asynchronous serial communications bus. The predefined signal may, for example, address directly the first device. Alternatively, the predefined signal may be a broadcast signal adapted to validate the calibration of the working oscillator of different devices.

According to a further embodiment of the method for operating a communication system, calibrating includes measuring a length T₂ of the predefined signal with the first device. Predefined implies that the predefined signal has a predefined length. This length may be a multiple of the pulse space. Measuring the length T₂ of the signal transmitted by the second device (e.g., with a reference oscillator) with the first device including the working oscillator may therefore allow for a more precise calibration.

According to another embodiment of the method for operating a communication system, the first signal and/or the predefined signal is a CAN-bus signal.

A CAN-bus is a standardized bus design. Devices for different purposes connectable to and controllable via a CAN-bus are available. Such devices may include variable speed drives, actuators, sensors, and grid controllers. The method for operating a communication system may therefore be applied to many existing communication systems.

According to a further embodiment of the method for operating a communication system, the method includes operating the first device in a pressurized environment. A pressurized containment for the first device to be used, for example, for subsea applications may be less prone to failure. The pressurized containment may require less space and less weight.

According to a second aspect, a communication system including a first device that includes a working oscillator and a calibration unit, a second device including a reference oscillator, and an asynchronous serial communications bus connecting the first device and the second device is provided. The calibration unit is adapted to calibrate the working oscillator using a pulse space of a signal transmittable from the second device over the asynchronous serial communications bus.

Such a communication system may be less expensive, as less accurate working oscillators may be used. Such a communication system may impose fewer restrictions to the environmental conditions (e.g., temperature, humidity, pressure).

According to an embodiment of the communication system, the reference oscillator is a crystal oscillator (e.g., a quartz oscillator). Crystal oscillators offer a high frequency accuracy and frequency stability that may make the crystal oscillators suitable as reference oscillators. Quartz oscillators are available for many frequencies and thus may allow a more flexible choice of bit rates.

According to an embodiment of the communication system, the reference oscillator is a ceramic oscillator. Ceramic oscillators are available in small dimensions and may need for operation only few external electrical components. Ceramic oscillators may be more resistant to mechanical stress and/or less expensive.

According to an embodiment, the working oscillator may be an RC oscillator. Such oscillator may be easily calibrated and is cost efficient to implement.

According to another embodiment of the communication system, the asynchronous serial communications bus is a CAN-bus. A CAN-bus is a standardized bus design. Devices for different purposes connectable to and controllable via a CAN-bus are available. Such devices may include variable speed drives, actuators, sensors, and grid controllers. The communication system may therefore be composed of standard CAN-bus devices.

According to an aspect, a program element is provided. The program element, when being executed by a data processer, is adapted for carrying out the method for operating a communication system.

One or more of the present embodiments may be realized by a computer program (e.g., software). One or more of the present embodiments may also be realized by one or more specific electronic circuits (e.g., hardware). One or more of the present embodiments may also be realized in a hybrid form (e.g., in a combination of software modules and hardware modules).

In one embodiment, a computer-readable medium, on which a computer program for processing a physical object is stored, is provided. The computer program, when executed by a data processor, is configured for controlling and/or for carrying out the method set forth above and below.

### BRIEF DESCRIPTION OF THE DRAWINGS

FIG. 1 shows one embodiment of a communication system to be at least partly operated below sea-level.

FIG. 2 shows an exemplary asynchronous serial communications signal.

FIG. 3 shows an exemplary embodiment of a device.

FIG. 4 shows one embodiment of a CAN-bus frame.

FIG. 5 shows an exemplary embodiment of a calibration and validation routine.

### DETAILED DESCRIPTION

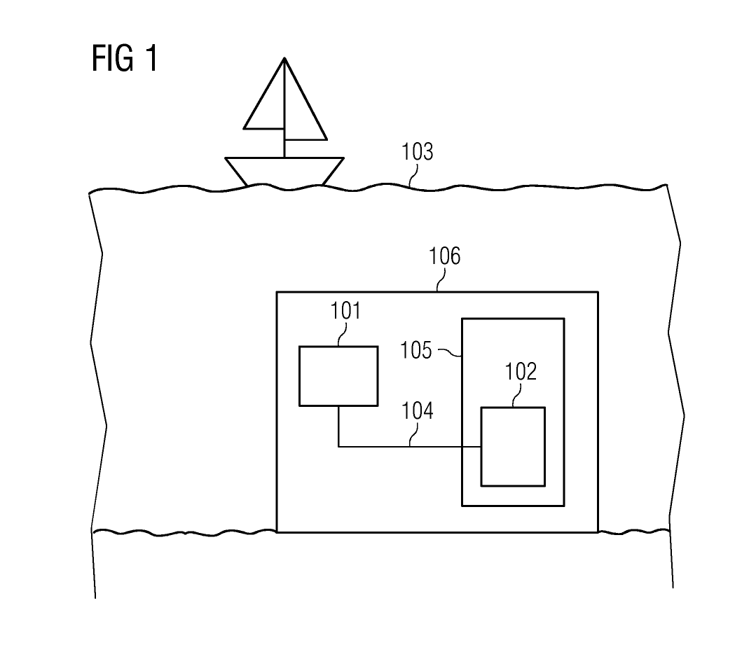

FIG. 1 shows one embodiment of a communication system for subsea operation. The communication system may be used, for example, to control a subsea power grid or variable speed drives (VSD). The communication system includes a first device 101 and a second device 102. Both the first device 101 and the second device 102 are operated below sea-level 103. The first device 101 and the second device 102 are connected to each other via a CAN-bus 104, an asynchronous serial communications bus.

The control electronics used for the second device 102 may not handle a pressure of up to 300 bars. Accordingly, the second device 102 is placed in an atmospheric canister 105. The atmospheric canister 105 and the first device 101 are placed in a fluid filled container 106 with high pressure. In the atmospheric canister 105, there are few restrictions concerning the components that may be used, and the second device 102 therefore may include a reference oscillator like a crystal oscillator (e.g., a quartz oscillator).

In pressurized environments, not all oscillators are suitable. Crystal oscillators like quartz oscillators provide the correct frequency by physical vibration at the oscillator frequency. This vibration requires a free space inside the encapsulation. For pressurized subsea applications, this presents a problem, as these encapsulations may collapse due to the increased pressure. Crystal oscillators in a hard material may cope with the pressure. As an alternative, all electronics may be placed in an atmospheric canister with penetrators to allow connections. However, this is a very expensive solution that also requires a lot more space and weight. Accordingly, non-vibrating oscillators (e.g., RC-oscillators) may be provided. RC-oscillators use an RC-network, a combination of resistors and capacitors, for a frequency selective part. An RC-oscillator is dependent on supply voltage, pressure and temperature and is to be calibrated to be usable for asynchronous communications (e.g., over a CAN-bus).

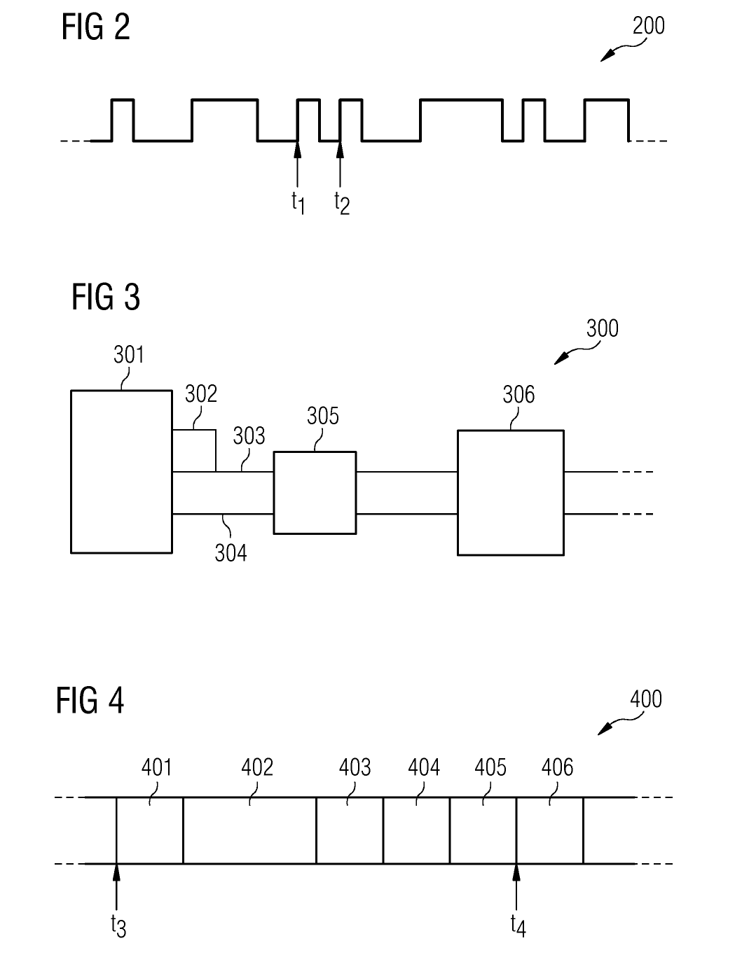

FIG. 2 shows an exemplary asynchronous serial communications signal received by the first device 101, which has been transmitted by the second device 102. The level switches from a high level to a low level and back, the pulse space depending on the data transmitted. For a time T_{A}, the second device 102 measures the time according to the frequency of a working oscillator of the second device 102 between a first rising edge and a subsequent rising edge and stores a shortest pulse space T₁=t₂−t₁. Due to a predefined bit rate and the reference oscillator of the second device 102, the first device 101 may determine a deviation of a working oscillator of the first device 101 from the reference oscillator, thus calibrating the working oscillator.

The determined deviation may be used to adjust the frequency of an adjustable working oscillator to be essentially equal to the frequency of the reference oscillator. If the working oscillator is, for example, an RC-oscillator, values of a resistance and a capacitance of the working oscillator may be changed. Alternatively or in addition, the calculation of the bit rate may be adapted to the determined deviation to provide a stable data transmission. For example, the bit rate may be derived from the frequency of the working oscillator and the determined deviation so that the bit rate is equal to the bit rate of the second device 102.

FIG. 3 shows another exemplary communication system 300 with a pressurized first device 301 including a capturing input 302, a receiving input 303, and a sending output 304. The first device 301 may be a digital programmable device (e.g., a microprocessor), a digital signal processor (DSP), a complex programmable logic device (CPLD), a field-programmable gate array (FPGA), or other digital logic.

The first device 301 may include, for example, an Atmel AVR microcontroller AT90CAN32/64/128. An Atmel AVR microcontroller AT90CAN32/64/128 includes an internal RC-oscillator that may be used as a working oscillator. The internal RC-oscillator may be calibrated using an oscillator calibration (OSCCAL) register. An Atmel AVR microcontroller AT90CAN32/64/128 includes internal timers and capturing inputs that allow for a measurement of pulse spaces on the CAN-bus. An Atmel AVR microcontroller AT90CAN32/64/128 also includes a CAN-bus interface on a chip. This allows for the complete calibration of the first device 301 without added external components. An Atmel AVR microcontroller AT90CAN32/64/128 further includes a system clock. The system clock may be used as a backup working oscillator and enhances the reliability of the first device 301.

Additionally, the system clock may be used to provide an accurate clock signal for auxiliary devices like sensors or actuators using either a pulse width modulation (PWM) output pin or a clock output (CLKO) pin of the Atmel AVR microcontroller AT90CAN32/64/128.

The capturing input 302 of the first device is internally connected to a high frequency timer associated to the working oscillator and externally connected to the receiving input 303 of the first device 301. Receiving input 303 and sending output 304 are connected to the second device 306 via a transceiver 305.

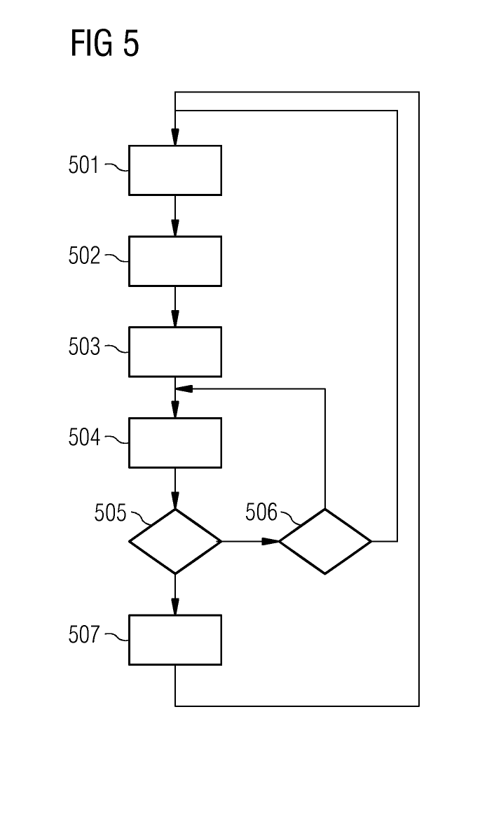

To verify that the calibration has been successful, the electronics with the reference crystal oscillator periodically sends a validation frame. This validation frame may also be used for further calibration to achieve even higher accuracy. A standard CAN-bus frame 400 is shown in FIG. 4. The CAN-bus frame 400 includes a start field 401, an arbitration field 402, a control field 403, a cyclic redundancy check field 404, an acknowledge field 405 and an end field 406.

The arbitration field 402 includes a unique identifier that triggers the device to be validated. The cyclic redundancy check field 404 may be used to verify that messages may be received without an error. Additionally, the data included in the control field 403 may be predefined to provide a further verification.

Predefining the data included in the control field 403 may enable a more accurate calibration. For calibrating, the first device may trigger, for example, on the start of a frame signal specified by the start field 401 and again on the end of a frame signal specified by the end field 406. As the data included in the control field 403 is predefined, and start field 401, arbitration field 402, cyclic redundancy check field 404 and acknowledge field 405 have given length, time T₂ between the start of frame signal t₃ and the end of frame signal t₄ is known and may be compared to the time actually measured by the first device.

The maximum size of an extended identifier CAN-bus frame with 8 bytes of data from the start field 401 to the beginning of the end field 406 is 121 bits. This may therefore provide a calibration with a 121 times higher resolution than the single pulse space time calibration value.

FIG. 5 shows an exemplary embodiment of a calibration and validation routine.

In act 501, for a time Tₐ, a first device measures the pulse space time T₁ between a first rising edge t₁ and the subsequent rising edge t₂ of a CAN-bus signal (e.g., an asynchronous serial communications signal) transmitted by a second device. The smallest value Tₘᵢₙ thus obtained is stored.

Based on Tₘᵢₙ, in act 502, the first device determines the deviation of a working oscillator of the first device from the reference oscillator, thus calibrating the working oscillator. The determined deviation or calibration value is used to select a correction value to adjust the frequency of the working oscillator to the frequency of the reference oscillator. Alternatively or in addition, a bit rate may be calculated from the now known actual frequency of the reference oscillator.

In act 503, the first device is set to operate with the adjusted working oscillator and/or the selected bit rate. Furthermore, the first device starts a timer t_{b} and begins scanning the CAN-bus for CAN-bus frames.

The time T₂=t₄−t₃ between the beginning of the start of frame signal and the beginning of the end of frame signal is measured for every received CAN-bus in act 504.

If in act 505 it is determined that the CAN-bus frame received is a validation frame, the communication is verified, and in act 507, the time T₂ may be used for a more precise adjustment of the working oscillator frequency.

Should the CAN-bus frame not be a validation frame, the routine proceeds from act 505 to act 506 and determines if t_{b} has reached T_{b} (e.g., the validation time has expired). If the result is positive, the routine restarts with act 501. In the opposite case, the routine continues scanning the CAN-bus for CAN-bus frames and measuring the time T₂.

Tₐ and T_{b} are times that are to be set according to the traffic on the CAN-bus and the desired bit rate. The routine, as described hereinbefore, may be performed a plurality of times. In this way, non-linear or non-continuous frequency deviations or adjusting capabilities of working oscillators (e.g., RC-oscillators) may be accounted for.

The method for operating an asynchronous serial communications bus hereinbefore has been described for a communication system with a first device and a second device. However, the communication system may include more than two devices.

Only one of the devices may include a reference oscillator to establish a stable data transmission. The working oscillators of all the other devices may be calibrated using this reference oscillator. For a stable data transmission, the devices are to operate at the same bit rate. The absolute value of the bit rate is of minor importance. Therefore, in an application where the actual bit rate is not crucial for other purposes, a crystal oscillator may therefore be omitted. In a pressurized system, this enables the use of an RC-oscillator and provides a reliable system with no added cost or even reduced cost with respect to crystal oscillators. No casting of the crystal oscillators is needed.

As an alternative, a casted crystal oscillator may be used by default with an RC-oscillator as a redundant backup oscillator. In case of a fault in the crystal oscillator, the system is able to continue to work with the RC-oscillator when the system has been calibrated according to the described routine.

In a non-pressurized environment using an asynchronous serial communications bus like a CAN-bus (e.g., a road vehicle), the calibration method leads to reduced component cost.

The term “comprising” does not exclude other elements or steps, and the use of articles “a” or “an” does not exclude a plurality. Also, elements described in association with different embodiments may be combined. Reference signs in the claims should not be construed as limiting the scope of the claims.

The claimed method, system, and program element may offer substantial advantages over known systems.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A subsea communication system comprising:
a pressurized environment comprising a first device, the first device including a working oscillator and a calibration unit;
an atmospheric canister comprising a second device, the second device including a reference oscillator; and
an asynchronous serial communications bus connecting the first device and the second device,
wherein the calibration unit is configured to calibrate the working oscillator using a pulse space of a signal transmittable from the second device over the asynchronous serial communications bus.

2. The subsea communication system of claim 1, wherein the reference oscillator is a crystal oscillator, in particular a quartz oscillator.

3. The subsea communication system of claim 1, wherein the reference oscillator is a ceramic oscillator.

4. The subsea communication system of claim 1, wherein the asynchronous serial communications bus is a CAN-bus.

5. A method for operating a subsea communication system, the subsea communication system comprising a pressurized environment, the pressurized environment comprising a first device, the first device including a working oscillator and a calibration unit, the subsea communication system further comprising an atmospheric canister comprising a second device, the second device including a reference oscillator, the subsea communication system further comprising an asynchronous serial communications bus connecting the first device and the second device, the method comprising:
calibrating the working oscillator of the first device connected to the asynchronous serial communications bus, the calibrating comprising:
defining a measurement time; and
measuring and selecting a predefined pulse space of a first signal formed by a plurality of predefined discrete pulse spaces, generated by a second device comprising a reference oscillator, and received by the first device during the measurement time over said asynchronous serial communications bus.

6. The method for operating the subsea communication system of claim 5, further comprising adjusting a frequency of the working oscillator.

7. The method for operating the subsea communication system of claim 5, further comprising adapting a calculation of an operating bit rate of the first device.

8. The method for operating the subsea communication system of claim 1, further comprising validating the calibration of the working oscillator of the first device.

9. The method for operating the subsea communication system of claim 8, wherein validating the calibration of the working oscillator of the first device comprises periodically sending predefined signals from the second device over the asynchronous serial communications bus.

10. The method for operating the subsea communication system of claim 9, wherein calibrating comprises measuring a length of the predefined signal by the first device.

11. The method for operating the subsea communication system of claim 9, wherein the first signal, the predefined signal, or the first signal and the predefined signal are a CAN-bus signal.

12. The method for operating the subsea communication system of claim 5, further comprising operating the first device in a pressurized environment.

13. The method for operating the subsea communication system of claim 5, further comprising:
determining from the measured and selected predefined pulse space a frequency deviation between the reference oscillator and the working oscillator; and
calibrating the working oscillator in accordance with the determined frequency deviation.

14. A program element, the program element comprising instructions, when executed by a data processer, being for operating a subsea communication system, the subsea communication system comprising a pressurized environment, the pressurized environment comprising a first device, the first device including a working oscillator and a calibration unit, the subsea communication system further comprising an atmospheric canister comprising a second device, the second device including a reference oscillator, the subsea communication system further comprising an asynchronous serial communications bus connecting the first device and the second device, the instructions comprising:
calibrating the working oscillator of the first device connected to the asynchronous serial communications bus, the calibrating comprising:
defining a measurement time; and
measuring and selecting a predefined pulse space of a first signal formed by a plurality of predefined discrete pulse spaces, generated by a second device comprising a reference oscillator, and received by the first device during the measurement time over said asynchronous serial communications bus.

15. (canceled)

16. The subsea communication system of claim 1, wherein the pressurized environment comprises a fluid filled container.

17. The subsea communication system of claim 2, wherein the reference oscillator comprises a quartz oscillator.
